(19) United States
(12) Patent Application Publication
(10) Pub. No.: US 2019/0359850 A1
(43) Pub. Date: Nov. 28, 2019

(54) LOW-SOLVENT COATING SYSTEMS FOR TEXTILES

(71) Applicant: Covestro Deutschland AG, Leverkusen (DE)

(72) Inventors: Jürgen KÖCHER, Langenfeld (DE); Rafael LANGER, Odenthal (DE)

(21) Appl. No.: 16/477,550

(22) PCT Filed: Jan. 10, 2018
(86) PCT No.: PCT/EP2018/050587

§ 371 Date: Jul. 12, 2019

(30) Foreign Application Priority Data
Jan. 13, 2017 (EP) 17151308.8

(51) Int. Cl. C09D 175/08; C08G 18/08; C08G 18/12; C08G 18/32; C08G 18/40; C08G 18/42; C08G 18/48; C08G 18/66; C08G 18/76; C08G 18/28

(52) U.S. Cl. CPC C09D 175/08; C08G 18/0852; C08G 18/12; C08G 18/3215; C08G 18/4018; C08G 18/4238; C08G 18/3234; C08G 18/4825; C08G 18/4829; C08G 18/4837; C08G 18/6674; C08G 18/7642; C08G 18/285; C08G 18/4812

(57) ABSTRACT

The invention relates to a coating composition for elastic coating of textile materials, containing at least one immobilized, isocyanate-terminated prepolymer (component A), wherein the isocyanate-terminated prepolymer is produced from a polyol component a) and from an araliphatic isocyanate component b), and the end-positioned isocyanate groups are blocked with N-alkyl benzylamines and/or partially with N-alkyl benzylamines and partially with 3,5-dimethyl pyrazole, at least one polyamine (component B) and <30 wt %, based on the total mass the of coating composition of at least one organic solvent. The invention further relates to a method for coating substrates with the coating composition according to the invention, to the substrate which can be obtained thereby, and to the use of the coating composition according to the invention for producing elastic coatings or elastic films.

The present invention relates to a specific, low-solvent coating composition for the elastic coating of textile materials, comprising component A), at least one blocked, isocyanate-terminated prepolymer, and component B), at least one polyamine. Further subjects of the invention are a process for the coating of substrates, especially textiles, with the coating composition of the invention, and also the coated substrate obtainable in the process, and also the use of the coating composition of the invention for producing elastic coatings or elastic films.

Low-solvent coating compositions for textiles, based on polyurethaneureas, are common knowledge and are described for example in DE 2 902 090 A1. The coating systems in this case comprise 2 constituents, a ketoxime-blocked polyisocyanate and a compound having two amino groups, and these constituents react with one another at temperatures above 120° C. At these temperatures, the ketoxime groups are split off and the NCO groups are liberated and are available for reaction with the amine component. The systems described also have good storage stability at ambient temperatures. Elastic films can be obtained from the coating compositions, said films enjoying high mechanical stability. In the course of film formation, however, ketoximes are released, such as butanone oxime. Butanone oxime is presently suspected to be a putative substance injurious to health. Evaluations of this compound are currently underway to evaluate the toxicology of the compound. Depending on the outcome of these studies, there might in certain areas be changes in the use of this product, either by an obligation to additional monitoring measures or a desire for substitution of this product.

Consequently a demand exists for alternative, low-solvent coating compositions which are storage-stable at ambient temperature and which do not release ketoximes in their crosslinking or full reaction and film formation. The coatings obtained ought nevertheless to exhibit the advantageous properties of the prior-art systems.

DE 3434881 and EP 0787754 describe solid, blocked polyisocyanates as curing agents for powder coating materials, with blocking agents cited including aralkyl-substituted secondary amines such as tert-butylbenzylamine. Coating materials of this kind cure even at less than 170° C. and exhibit no tendency toward discoloration even on baking, overbaking or weathering. Blocking agents described for polyisocyanates in thermosetting liquid-coating applications are such amines, especially N-tert-butyl-N-benzylamine, in patents EP 1375550, EP 1375551 and EP 1375552.

Likewise known as blocking agents for polyisocyanates are dimethylpyrazoles (D. A. Wicks and Zeno W. Wicks Jr., Progress in Organic Coatings 43 (2001), 131-140; D. A. Wicks and Zeno W. Wicks Jr., Progress in Organic Coatings 36 (1999), 148-172).

The blocking agents described have not to date been used for producing elastic textile coatings. In the blocking of the known low-solvent coating compositions for textiles, based on polyurethaneureas (in accordance, for example, with DE 2 902 090 A1), a problem arising is that in the case of a switch of blocking agent from ketoximes to—for example—tert-butylbenzylamine or 3,5-dimethylpyrazole, the compositions no longer exhibit sufficient storage stability at room temperature (pot life). This means that after the two components have been mixed, the viscosity climbs so rapidly that working is no longer possible after just a short time, in many cases, indeed, within an hour, at room temperature.

It was an object of the present invention, therefore, to provide low-solvent coating compositions which are suitable for textile coating, which are storage-stable at ambient temperature, and which do not release any ketoximes in the coating process. An intention, moreover, was that the films obtained from such coating compositions should have good elastic and mechanical properties.

This object has been achieved in accordance with the invention by means of a coating composition for the elastic coating of textile materials, comprising at least one blocked, isocyanate-terminated prepolymer (component A), the isocyanate-terminated prepolymer being prepared from a polyol component a) and an araliphatic isocyanate component b), and the terminal isocyanate groups being blocked with N-alkyl-benzylamines or partly with N-alkyl-benzylamines and partly with 3,5-dimethylpyrazole, at least one polyamine (component B), and ≤30% by weight, preferably ≤25% by weight, or preferably ≤20% by weight, based on the total mass of the coating composition, of at least one organic solvent.

The araliphatic isocyanate component b) preferably has at least two isocyanate groups. Araliphatic isocyanate component b) in the context of the invention means that the isocyanate component b) has at least one aliphatic carbon atom and at least one aromatic hydrocarbon group. At least one of the at least two terminal isocyanate groups of the araliphatic isocyanate component b) is preferably bonded to an aliphatic carbon atom. With further preference, at least two of the at least two isocyanate groups of the araliphatic isocyanate component b) are each bonded to an aliphatic carbon atom.

Preferred polyisocyanates for preparing the prepolymer component A are those which have the isocyanate group bonded to an aliphatic C atom with their isocyanatoalkyl groups being linked to one another preferably via an aromatic radical. Preferred polyisocyanates of this kind are tetramethylxylylene diisocyanate (m- and/or p-TMXDI). The prepolymers A more preferably comprise xylylene diisocyanate (m- and/or p-XDI).

In one preferred embodiment of the coating composition, the terminal isocyanate groups of the isocyanate-terminated prepolymer are selected from the group consisting of m-tetramethylxylylene diisocyanate (m-TMXDI), p-tetramcthylxylylene diisocyanate (p-TMXDI), m-xylylene diisocyanate (m-XDI), p-xylylene diisocyanate (p-XDI) or a mixture of at least two thereof. Preferably the terminal isocyanate groups of the isocyanate-terminated prepolymer consist of xylylene diisocyanate (m- and/or p-XDI).

It has surprisingly been found that the low-solvent coating compositions of the invention are suitable for the coating of textiles and, without releasing ketoximes, form elastic films having good mechanical properties. In particular the coating compositions of the invention before processing also have sufficiently long storage-stability at room temperature. This is not the case when using prepolymers which are based purely on aromatic polyisocyanates or which have a high proportion of aromatic polyisocyanates.

The coating composition comprises a blocked, isocyanate-terminated prepolymer (component A), the isocyanate-terminated prepolymer being prepared from a polyol component a) and an isocyanate component b), and the terminal isocyanate groups being blocked with N-alkyl-benzylamines or partly with N-alkyl-benzylamines and partly with 3,5-dimethylpyrazole.

The coating composition comprises preferably 30% to 95% by weight and more preferably 50% to 95% by weight of component A), based on the total mass of the coating composition.

The polyol component a) used for preparing the prepolymer component A) preferably comprises at least one polyol preferably selected from the group consisting of polyether polyols, polyester polyols, polycarbonate polyols, polyethercarbonate polyols, and polyestercarbonate polyols, or a mixture of at least two thereof. The number-average molar weight Mₙ of the at least one polyol is preferably in a range from 300 to 8000 g/mol, or preferably in a range from 400 to 7000 g/mol, or preferably in a range from 500 to 6000 g/mol. The at least one polyol preferably has an average hydroxyl group functionality in a range from 1.5 to 4.0, or preferably in a range from 1.8 to 3.5, or preferably in a range from 2.0 to 3.0. The expression “polymeric” polyols, such as polyether polyols or polyester polyols, means here in particular that the aforementioned polyols have at least two, preferably at least three, interconnected repeat units of the same or alternating structural units.

The number-average molecular weight for the purposes of this specification is always determined by gel permeation chromatography (GPC) in tetrahydrofuran at 23° C. The procedure is in accordance with DIN 55672-1: “Gel permeation chromatography, Part 1—Tetrahydrofuran as eluent” (SECurity GPC System from PSS Polymer Service, flow rate 1.0 mL/min; columns: 2×PSS SDV linear M, 8×300 mm, 5 m; RID detector). Polystyrene samples of known molar mass are used for calibration. The number-average molecular weight is calculated with software support. Baseline points and evaluation limits are fixed according to DIN 55672 Part 1.

Through variation in the number-average molecular weights and in the functionality of the polyols it is possible to influence the properties of the resultant films, such as, for example, elasticity, moduli, melting temperature, and water swelling.

Compounds suitable as polyol component a) are preferably selected from the group consisting of bifunctional polypropylene oxide ethers based on bisphenol A, bifunctional polypropylene oxide ethers based on propylene glycol, trifunctional polyethers of propylene oxide and ethylene oxide based on glycerol, or a mixture of at least two thereof.

Polyol components used for preparing the polyurethane prepolymers may be relatively high molecular weight polyether polyols known from polyurethane chemistry, which are obtainable in a conventional way by alkoxylation of suitable starter molecules.

Examples of suitable starter molecules include simple polyols such as ethylene glycol, 1,2- and/or 1,3-propylene glycol, and 1,4-butanediol, 1,6-hexanediol, neopentyl glycol, 2-ethylhexane-1,3-diol, glycerol, trimethylolpropene, pentaerythritol, sorbitol, and also low molecular weight, hydroxyl-containing esters of such polyols with aliphatic or aromatic dicarboxylic acids, and also low molecular weight products of ethoxylation or propoxylation of such simple polyols or any desired mixtures of at least two such modified or unmodified alcohols, water, organic polyamines having at least two N—H bonds, or any desired mixtures of at least two such starter molecules. Also suitable are aromatic hydroxyl compounds such as, for example, bisphenol A. Suitability for the alkoxylation is possessed by cyclic ethers such as tetrahydrofuran and/or alkylene oxides such as ethylene oxide, propylene oxide, butylene oxides, styrene oxide or epichlorohydrin, especially ethylene oxide and/or propylene oxide, which may be used in any order or else in a mixture of at least two thereof for the alkoxylation.

Suitable polyether polyols made up of repeating propylene oxide and/or ethylene oxide units are, for example, the Desmophen®, Acclaim®, Arcol®, Baycoll®, Bayfill®, Bayflex®, Baygal®, PET® and polyether polyols from Covestro AG (for example Desmophen® 3600Z, Desmophen® 1900U. Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriola E products from BASF SE, suitable homopolypropylene oxides are, for example, the Pluriola P products from BASF SE, and suitable mixed copolymers of ethylene oxide and propylene oxide are, for example, the Pluronica PE or Pluriola RPE products from BASF SE.

Suitable polyester polyols are, for example, the known-per-se polycondensates of di- and optionally tri- and tetraols and di- and optionally tri- and tetracarboxylic acids or hydroxycarboxylic acids or lactones. Also employable instead of the free polycarboxylic acids are the corresponding polycarboxylic anhydrides or corresponding polycarboxylic esters of lower alcohols to prepare the polyesters, or mixtures of at least two of these.

Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or hydroxypivalic acid neopentyl glycol ester, or mixtures of at least two thereof. Also employable as well are polyols such as trimethylolpropane, glycerol, erythritol, pentaerythritol, trimethylolbenzene or trihydroxyethyl isocyanurate, or mixtures of at least two thereof.

Employable dicarboxylic acids include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and/or 2,2-dimethylsuccinic acid, or mixtures of at least two thereof. It is also possible to use the corresponding anhydrides as an acid source.

Provided that the average functionality of the polyol to be esterified is greater than 2 it is also possible additionally to use monocarboxylic acids such as benzoic acid and hexanecarboxylic acid.

Hydroxycarboxylic acids that may be co-used as co-reactants in the production of a polyester polyol having terminal hydroxyl groups are, for example, hydroxycaproic acid, hydroxybutyric acid, hydroxydecanoic acid, hydroxystearic acid and the like, and also mixtures of at least two thereof. Suitable lactones are caprolactone, butyrolactone and homologs. Preference is given to caprolactone.

Preferred polycarbonate polyols are those obtainable, for example, by reaction of carbonic acid derivatives, such as diphenyl carbonate, dimethyl carbonate, diethyl carbonate or phosgene, with polyols, preferably diols. Useful diols of this kind include, for example, ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, di-, tri- or tetraethylene glycol, dipropylene glycol, polypropylene glycols, dibutylene glycol, polybutylene glycols, bisphenol A, tetrabromobisphenol A, but also lactone-modified diols, or mixtures of at least two thereof. As polyols for preparing the polycarbonate polyols it is also possible to use polyester polyols or polyether polyols.

Preferably, the diol component for preparing the polycarbonate polyols contains 40% to 100% by weight of hexanediol, preferably hexane-1,6-diol and/or hexanediol derivatives, preferably those having not only terminal OH groups but also ether or ester groups, for example products which have been obtained by reaction of 1 mol of hexanediol with at least 1 mol, preferably 1 to 2 mol, of caprolactone, or by etherification of hexanediol with itself to give di- or trihexylene glycol. It is also possible to use polyether polycarbonate diols. The hydroxyl polycarbonates should be essentially linear. However, they may optionally be lightly branched by the incorporation of polyfunctional components, especially low molecular weight polyols. Suitable examples for this purpose are glycerol, trimethylolpropane, hexane-1,2,6-triol, butane-1,2,4-triol, trimethylolpropane, pentaerythritol, chinit, mannitol, sorbitol, methyl glycoside or 1,3,4,6-dianhydrohexitols. Preferred polycarbonates are those based on hexane-1,6-diol, and also co-diols with modifying activity such as, for example, butane-1,4-diol, or else on ε-caprolactone. Further preferred polycarbonate diols are those based on mixtures of hexane-1,6-diol and butane-1,4-diol. Examples of polycarbonate polyols are found for example in EP 1359177 A. As polycarbonate diols it is possible for example to use the Desmophen® C products from Covestro AG, such as Desmophen® C 1100 or Desmophen® C 2200, for example.

The aforementioned polyethercarbonate polyols, polycarbonate polyols and/or polyetherestercarbonate polyols may in particular be obtained by reaction of alkylene oxides, preferably ethylene oxide, propylene oxide or mixtures thereof, optionally further comonomers, with CO₂ in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and CO₂ is provided for example in Chemical Communications 47 (2011) 141-163. The use of different catalyst systems, reaction conditions and/or reaction sequences results in the formation of random, alternating, block-type or gradient-type polyether carbonate polyols, polycarbonate polyols and/or polyether ester carbonate polyols.

The polyol component a) preferably comprises at least two different polyols. The at least two different polyols in this case may differ in at least one of the following properties:
I) their molecular mass;
II) their OH functionality;
III) the structure of their repeat units;
IV) their amount in the mixture of at least two polyols;
V) all of the aforementioned properties.

In one preferred embodiment of the coating composition, the polyol component a) contains at least two different polyols: a first polyol and at least one further polyol. The polyol component a) preferably comprises the first polyol in an amount in a range from 0.1% to 50% by weight, or preferably in a range from 1% to 30% by weight, or preferably in a range from 5% to 20% by weight. The polyol component preferably comprises all further polyols in an amount in a range from 50% to 99% by weight, or in a range from 60% to 95% by weight, or preferably in a range from 70% to 90% by weight. Each of the at least two polyols is preferably selected from the group of the polyols mentioned above in connection with the polyol component a).

Suitable araliphatic starting diisocyanates for preparing the polyisocyanate components A) are any desired diisocyanates whose isocyanate groups are bonded via optionally branched aliphatic radicals to an optionally further-substituted aromatic moiety, such as, for example, 1,3-bis(isocyanatomethyl)benzene (m-xylylene diisocyanate, m-XDI), 1,4-bis(isocyanatomethyl)benzene (p-xylylene diisocyanate, p-XDI), 1,3-bis(2-isocyanatopropan-2-yl)benzene (m-tetramethylxylylene diisocyanate, m-TMXDI), 1,4-bis(2-isocyanatopropan-2-yl)benzene (p-tetramethylxylylene diisocyanate, p-TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene, 1,4-bis(isocyanatomethyl)naphthalene, and also any desired mixtures of these diisocyanates.

The aforesaid starting diisocyanates may also be reacted as polyisocyanates for reaction with the selected polyols to give the prepolymers.

The polyisocyanate component prepared from the stated araliphatic diisocyanates preferably comprises polyisocyanates that contain uretdione, isocyanurate, iminooxadiazinedione, urethane, allophanate, biuret and/or oxadiazinetrione groups and that are based on araliphatic diisocyanates which at 23° C. are present in solid form or have a viscosity of more than 150 000 mPas and whose isocyanate group content is from 10% to 22% by weight and whose monomeric araliphatic diisocyanate content is less than 1.0% by weight.

The polyisocyanate components A) may be prepared from the stated araliphatic diisocyanates by the customary methods for oligomerizing diisocyanates, as described for example in Laas et al., J. Prakt. Chem. 336, 1994, 185-200, and subsequent removal of the unreacted monomeric diisocyanates by distillation or extraction. Specific examples of low-monomer-content polyisocyanates of araliphatic diisocyanates are found for example in JP-A 2005161691, JP-A 2005162271, and EP-A 0 081 713.

Preferred polyisocyanates A) are those having uretdione, allophanate, isocyanurate, iminooxadiazinedione and/or biuret structure.

The prepolymers are prepared preferably by reaction of the polyols with araliphatic starting diisocyanates, as stated above. The prepolymers may be freed from monomeric starting diisocyanates by means of thin-film distillation. The direct reaction of the prepolymers without prior thin-film distillation is preferred.

With particular preference the araliphatic starting diisocyanates are those of the above-described kind based on xylylene diisocyanate (m-XDI, p-XDI) and/or tetramnethylxylylene diisocyanate (m- and p-TMXDI). Xylylene diisocyanate (m- or p-XDI) is especially preferred.

The for preparing the araliphatic starting diisocyanates can be prepared by any desired methods, as for example by phosgenation in the liquid phase or gas phase or by a phosgene-free route, as for example by urethane cleavage.

Besides the components a) and b) it is also possible to use further isocyanate-reactive compounds for preparing the prepolymers.

It is also possible, for example, to use, at least in part, low molecular weight polyols for preparing the isocyanate-containing prepolymers. Suitable low molecular weight polyols are short-chain aliphatic, araliphatic or cycloaliphatic diols or triols, i.e. those containing 2 to 20 carbon atoms. Examples of diols are ethylene glycol, diethylene glycol, triethylene glycol, tetraethylene glycol, dipropylene glycol, tripropylene glycol, propane-1,2-diol, propane-1,3-diol, butane-1,4-diol, neopentyl glycol, 2-ethyl-2-butylpropanediol, trimethylpentanediol, positionally isomeric diethyloctanediols, 1,3-butylene glycol, cyclohexanediol, cyclohexane-1,4-dimethanol, hexane-1,6-diol, cyclohexane-1,2- and -1,4-diol, hydrogenated bisphenol A (2,2-bis(4-hydroxycyclohexyl)propene), 22-dimethyl-3-hydroxypropyl 2,2-dimethyl-3-hydroxypropionate. Preferred are 1,4-butanediol, 1,4-cyclohbexanedimethanol, and 1,6-hexanediol, or mixtures of at least two thereof. Examples of suitable triols are trimethylolethane, trimethylolpropane or glycerol, preference being given to trimethylolpropane.

It is additionally possible, as well as the short-chain diols, to use low molecular weight amines or amino alcohols as well. Compounds of this kind are diamines or polyamines, and also hydrazides, e.g., hydrazine, 1,2-ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-,3- and -1,4-xylylenediamine, and 4,4-diaminodicyclohexylmethane, dimethylethylenediamine, hydrazine, adipic dihydrazide, 1,4-bis(aminomethyl)cyclohexane, 4,4′-diamino-3,3′-dimethyldicyclohexylmethane, and other (C₁-C₄) di- and tetraalkyldicyclohexylmethanes, e.g. 4,4′-diamino-3,5-diethyl-3′,5′-diisopropyldicyclohexylmethane, or mixtures of at least two thereof. Contemplated generally as diamines or amino alcohols are low molecular weight diamines or amino alcohols which contain active hydrogen differing in reactivity toward NCO groups, such as compounds which as well as a primary amino group also contain secondary amino groups or which as well as an amino group (primary or secondary) also contain OH groups. Examples of such are primary and secondary amines, preferably selected from the group consisting of 3-amino-1-methylaminopropane, 3-amino-1-ethylaminopopane, 3-amino-1-cyclohexylaminopropane, 3-amino-1-methylaminobutane, and also amino alcohols, such as N-aminoethylethanolamine, ethanolamine, 3-aminopropanol, neopentanolamine and diethanolamine, or mixtures of at least two thereof. Preference is given to using diethanolamine.

It is also possible, furthermore, to use monofunctional compounds that are reactive with NCO groups, such as monoamines, especially mono-secondary amines, or monoalcohols. Examples include ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine and suitable substituted derivatives thereof or mixtures of at least two compounds from the list of those stated above.

The isocyanate-terminated prepolymer is prepared by reacting the components a) and b) and optionally further isocyanate-reactive components with one another, preferably by reacting the components a) and b) with one another.

In the preparation of the prepolymer, the polyol component a) may be introduced first and then the isocyanate component b) added, or else the opposite order of procedure may be followed.

The reaction takes place preferably at temperatures in a range of 23 and 120° C., or preferably in a range from 50 to 100° C. The temperature regime here may be varied before and after the addition of the individual components within this range. The reaction may be carried out with addition of customary solvent or in bulk, preferably in bulk.

The reaction may take place without catalyst, or else in the presence of catalysts which accelerate the formation of the urethanes from isocyanates and polyol components.

For the purpose of reaction acceleration it is possible to employ, for example, customary catalysts known from polyurethane chemistry, as component C) in the coating composition. By way of example mention may be made here of tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl-/N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, Nmethylpiperidine, N-dimethylaminoethylpiperidine, N,N′-dimethylpiperazine, N-methyl-N′-dimethylaminopiperazine, 1,8-diazabicyclo(5.4.0)undec-7-ene (DBU), 1,2-dimethylimidazole, 2-methylimidazole, N,N-dimethylimidazole-β-phenylethylamine, 1,4-diazabicyclo[2.2.2]octane, bis(N,N-dimethylaminoethyl) adipate; alkanolamine compounds, for example triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine and/or bis(dimethylaminoethyl) ether; metal salts, for example inorganic and/or organic compounds of iron, lead, bismuth, zinc and/or tin in customary oxidation states of the metal, for example iron(II) chloride, iron(II) chloride, bismuth(III) bismuth(III) 2-ethylhexanoate, bismuth(III) octoate, bismuth(III) neodecanoate, zinc chloride, zinc 2-ethylcaproate, tin(II) octoate, tin(II) ethylcaproate, tin(III) palmitate, dibutyltin(IV) dilaurate (DBTL), dibutyltin(IV) dichloride or lead octoate; amidines, for example 2,3-dimethyl-3,4,5,6-tetrahydropyrimidine; tetraalkylammonium hydroxides, for example tetramethylammonium hydroxide; alkali metal hydroxides, for example sodium hydroxide, and alkali metal alkoxides, for example sodium methoxide and potassium isopropoxide, and also alkali metal salts of long-chain fatty acids having 10 to 20 carbon atoms and optionally lateral OH groups.

Preferred catalysts C) for use are tertiary amines, bismuth compounds and tin compounds of the type mentioned.

The catalysts mentioned by way of example can be used individually or in the form of any desired mixtures with one another in the preparation of the coating composition of the invention, and are used, if at all, in amounts of 0.01% to 5.0% by weight, preferably 0.1% to 2% by weight, calculated as the total amount of catalysts used, based on the total amount of the starting compounds used.

The terminal isocyanate groups of the prepolymers are blocked with N-alkyl-benzylamine or partly with N-alkyl-benzylamine and partly with 3,5-dimethylpyrazole (DMP), preferably exclusively with N-alkyl-benzylamine.

Suitable blocking agents are N-alkyl-benzylamines as defined in paragraphs [0014] and [0015] of DE 102004057916. Especially preferred from this class of derivatives is N-benzyl-tert-butylamine. Also possible are mixtures of these benzylamine-based blocking agents with 3,5-dimethylpyrazole.

In one preferred embodiment of the coating composition, the terminal isocyanate groups of the prepolymer are blocked with N-tert-butylbenzylamine.

For the blocking, the isocyanate-terminated prepolymers are reacted wholly or partly with the blocking agents.

The blocking agent is preferably to be used in the amount such that the employed equivalents of the groups in the blocking agent that are suitable for isocyanate blocking correspond to at least 30 mol %, or preferably at least 50 mol %, or preferably at least than 95 mol %, of the amount of isocyanate groups to be blocked. A small excess of blocking agent may be useful in order to ensure a complete reaction of all the isocyanate groups. In general the excess is not more than 20 mol %, preferably not more than 15 mol %, or preferably not more than 10 mol %, based on the total amount of the isocyanate groups to be blocked. Very preferably the amount of groups in the blocking agent suitable for NCO blocking is therefore 95 mol % to 110 mol %, based on the amount of the isocyanate groups in the polyurethane prepolymer that are to be blocked.

The blocking of the terminal isocyanate groups with DMP and secondary N-alkyl-benzylamines is carried out advantageously at temperatures of 23° C. to 100° C., or preferably at temperatures of 40 to 90° C. The blocking agents are preferably first added to the prepolymer in pure form. As reaction progresses, depending on the structure of the prepolymer, there may be a sharp rise in the viscosity. In that case, customary solvents may then be added in order to limit the rise in the viscosity.

The viscosity of the blocked prepolymers obtained is preferably <200 000 mPas, or preferably <150 000 mPas, or preferably <110 000 mPas. The viscosity here may also be adjusted by addition of organic solvents, in which case ≤30%, preferably ≤20%, or preferably ≤10%, or preferably ≤6%, by weight of organic solvent is used, based on the total mass of prepolymer and solvent.

The coating composition further comprises component B), at least one polyamine. Polyamines are understood in accordance with the invention to be amines which have at least two amino groups.

In one preferred embodiment of the coating composition, component B) comprises at least one diamine, or component B) consists exclusively of one or more diamines. Such polyamines may contain either primary or secondary amino groups or mixtures thereof.

Examples of suitable polyamines include the following: hydrazides, e.g., hydrazine, 1,2-ethylenediamine, 1,2- and 1,3-diaminopropane, 1,4-diaminobutane, 1,6-diaminohexane, isophoronediamine, isomer mixtures of 2,2,4- and 2,4,4-trimethylhexamethylenediamine, 2-methylpentamethylenediamine, diethylenetriamine, 1,3- and 1,4-xylylendiamine, α,α,α′,α′tetramethyl-1,3- and -1,4-xylylenediamine, and 4,4-diaminodicyclohexylmethane, dimethylethylenediamine, hydrazine, adipic dihydrazide, 1,4-bis(aminomethyl)cyclohexane, 4,4′-diamino-3,3′-dimethyldicyclohexylmethane, and other (C₁-C₄) di- and tetraalkyldicyclohexylmethanes, e.g., 4,4′-diamino-3,5-diethyl-3′,5′-diisopropyldicyclohexylmethane, 4,4′-diamino-33′,5,5′-tetramethyldicyclohexylmethane, or mixtures of at least two thereof.

Suitable polyamines contemplated also include low molecular weight diamines or amino alcohols which contain active hydrogen with differing reactivity toward NCO groups, such as compounds which as well as a primary amino group also have secondary amino groups or which as well as an amino group (primary or secondary) also have OH groups. Examples here are primary and secondary amines, such as 3-amino-1-methylaminopropene, 3-amino-1-ethylaminopropane, 3-amino-1-cyclohexylaminopropane, 3-amino-1-methylaminobutane, and also amino alcohols, such as N-aminoethylethanolamine, ethanolamine, 3-aminopropanol, neopentanolamine, and, preferably, diethanolamine, or mixtures of at least two thereof.

Other suitable polyamines are secondary polyamines which contain ester groups, the so-called polyaspartates. Polyaspartates are obtainable by the reaction of primary polyamines with maleates or fumarates. The primary polyamines in this case may be selected in particular from the group consisting of ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 2-methyl-1,5-pentanediamine, 1,6-hexanediamine, 2,5-dimethyl-2,5-hexanediamine, 2,2,4- and/or 2,4,4-trimethyl-1,6-hexanediamine, 1,7-heptanediamine, 1,8-octanediamine, 1,9-nonanediamine, 1,10-decanediamine, 1,1-undecanediamine, 1,12-dodecanediamine, I-amino-3-aminomethyl-3,5,5-trimethylcyclohexane, 2,4- and/or 2,6-hexahydrotolylenediamine, 2,4′- and/or 4,4′-diaminodicyclohexylmethane, 3,3′-dialkyl-4,4′-diaminodicyclohexylmethanes (such as 3,3′-dimethyl-4,4′-diaminodicyclohexylmethane and 3,3′-diethyl-4,4′-diaminodicyclohexylmethane), 4,4′-diamino-3,3′,5,5′-tetramethyldicyclohexylmethane, 1,3- and/or 1,4-cyclohexanediamine, 1,3-bis(methylamino)cyclohexane, 1,8-p-methanediamine, hydrazine, hydrazides of semicarbazidocarboxylic acid, bishydrazides, bissemicarbezides, phenylenediamine, 2,4- and 2,6-tolylenediamine, 2,3- and 3,4-tolylenediamine, 2,4′- and/or 4,4′-diaminodiphenylmethane, more highly functionalized polyphenylpolymethylpolyamines obtainable from the aniline/formaldehyde condensation reaction, N,N,N-tris(2-aminoethyl)amine, guanidine, melamine, N-(2-aminoethyl)-1,3-propanediamine, 3,3-diaminobenzidine, polyoxypropyleneamines, polyoxyethyleneamines, mixed propylene oxide/ethylene oxide-diamines (such as 3,3′-[1,2-ethanediylbis(oxy)]bis(1-propanamine)), 2,4-bis(4-aminobenzyl)aniline, and mixtures of at least two thereof. Preferred primary polyamines are 1-amino-3-aminomethyl-3,5,5-trimethylcyclohexane (isophorone diamine or IPDA), bis(4-aminocyclohexyl)methane, bis(4-amino-3-methylcyclohexyl)methane, 1,6-diaminohexane, 2-methylpentamethylenediamine, ethylenediamine, and 3,3′-[1,2-ethanediylbis(oxy)]bis(I-propanamine).

Suitable polyaspartates and their preparation are described for example in the patent applications US2005/0159560 A1, EP0403921 A1, EP0470461 A1 and also in U.S. Pat. Nos. 5,126,170, 5,214,086, 5,236,741, 5,243,012, 5,364,955, 5,412,056, 5,623,045, 5,736,604, 6,183,870, 6,355,829, 6,458,293, and 6,482,333, and in the published European patent application 667,362. Also known are aspartates which contain aldimine groups (see U.S. Pat. Nos. 5,489,704, 5,559,204, and 5,847,195). Secondary aspartic acid amide esters are known from U.S. Pat. No. 6,005,062.

Component B) preferably comprises 4,4′-diaminocyclohexylmethane, 4,4′-diamino-3,3′-dimethyldicyclohexylmethane, and 4,4′-diamino-3,3′,5,5′-tetramethyldicyclohexylmethane, or mixtures of at least two thereof.

In one preferred embodiment of the coating composition, the ratio of the isocyanate groups in component b) to hydroxyl groups in component a) is ≥1.5:1, or preferably ≥1.8:1, or preferably ≥1.9:1.

The polyol component a) preferably comprises or consists of a mixture of at least two polyol components, where the individual polyols may consist of polyether polyols, polyester polyols, polycarbonate polyols, polyethercarbonate polyols, polyester carbonate polyols, and polyetherestercarbonate polyols, preferably selected from the above-described polyols. The number-average molar weights Mₙ of the polyols are preferably in the range from 500 to 6000 g/mol, the average OH functionality preferably in the range 1.8 to 3.5, more preferably in a range from 2.0 to 3.0.

The coating composition comprises preferably 5% to 50% by weight or preferably 5% to 30% by weight of component B), based on the total mass of the coating composition.

In one preferred embodiment of the coating composition, the coating composition comprises ≤30%, preferably ≤15% or preferably ≤10% by weight, based on the total mass of coating composition, of at least one organic solvent C. The coating composition may therefore be referred to as a low-solvent composition.

Organic solvents which can be used are all of the solvents customary in the textile industry, particular suitability being possessed by esters, alcohols, ketones, for example butyl acetate, methoxypropyl acetate, methyl ethyl ketone, or mixtures of at least two of these solvents. Particular preference is given to methoxypropyl acetate.

The organic solvent may be added together with component A), with component B), but also separately before, during or after the mixing of A) and B). The organic solvent is preferably introduced into the composition together with component A). Alternatively the solvent is preferably added after mixing of components A) and B).

In one preferred embodiment the coating composition comprises no water.

In the coating composition of the invention, the weight ratio of component A) to component B) is preferably ≤10:4, more preferably ≤10:3.5, and very preferably ≤10:3.

In one preferred embodiment of the coating composition, the component b) has an average NCO functionality in a range from 1.5 to 4.0, preferably in a range from 1.8 to 3.8 or preferably in a range from 2.0 to 3.5.

In one preferred embodiment of the coating composition, the weight ratio of component A) to component B) is ≤10:3, or preferably ≤10:2 or preferably ≤10:1.5.

The ratio of component A) to component B) here is preferably chosen such that the equivalents ratio of amine groups to blocked NCO groups is from 0.8 to 1.1, more preferably from 0.9 to 1.05, and very preferably from 0.95 to 1.0.

The coating compositions of the invention may further comprise the auxiliaries and adjuvants that are known per se in the processing of textile coatings, such as, for example, pigments, UV stabilizers, antioxidants, fillers, propellants, matting agents, hand assistants, foam preventatives, light stabilizers, plasticizers and/or flow control assistants. These auxiliaries and adjuvants are preferably present in a concentration of ≤15% by weight, more preferably 0.01% to 10% by weight, based on the total weight of the coating composition.

The coating composition preferably comprises 30% to 95% by weight of component A), 2% to 50% by weight of component B), 0% to 15% by weight of component C), and 0% to 15% by weight of auxiliaries and adjuvants, where components A), B), C), and the auxiliaries and adjuvants add up to 100% by weight.

The coating composition is preferably prepared by mixing all of the components at 20 to 30° C. for 20 to 50 minutes. Advantageously, in particular, the components A) and B) are first stored separately and not mixed until, as far as possible, shortly before the application or processing of the coating composition.

Directly after the mixing of the components, the coating composition preferably has a viscosity which still enables the coating composition to be processed by the common methods employed in the textile industry, in particular by knife application. The viscosity of the coating composition here may also be influenced by auxiliaries and adjuvants, such as those identified above, for example.

The coating composition ought to be still processable at least 4 hours after mixing.

A further subject of the invention is a process for coating substrates, wherein the coating composition of the invention is applied to a substrate and crosslinked at a temperature in a range from 90 to 200° C., preferably in a range from 110 to 180° C., or preferably in a range from 130 to 170° C. The crosslinking in this case is accomplished by reaction of components A) and B) with one another, initiated in particular by the exposure to temperature. As a result of the exposure to temperature, the blocked polyisocyanate A) first undergoes transition, preferably at least partially, into an unblocked form, and more preferably the blocked polyisocyanate A) here undergoes transition fully into an unblocked form. The deblocked isocyanate groups are then able to react fully, with crosslinking, with the amino groups of component B).

With particular preference the crosslinking takes place using temperature profiles in which, in the course of the crosslinking time, the temperature is raised in stages within the specified temperature range.

The crosslinking time under temperature exposure amounts in total to preferably from 1 to 15 minutes, more preferably from 2 to 10 minutes, and very preferably from 2 to 5 minutes.

The coating compositions of the invention can be applied to the substrate in one or more coats.

The coating composition may be applied to the substrate by the customary application or coating installations, for example a doctor, e.g., a coating knife, rolls or other devices. Printing, spraying is also possible. Application by doctor blades is preferred. The application can be effected on one or both sides. Application may take place directly or via transfer coating, preferably via transfer coating.

In the process of the invention, quantities preferably of 100 to 1000 g/m² are applied to the substrate.

Suitable substrates are preferably textile materials, sheetlike substrates made of metal, glass, ceramic, concrete, natural stone, leather, natural fibers, and plastics such as PVC, polyolefins, polyurethane or the like. Three-dimensional structures are also suitable as carrier materials. With particular preference the substrate is a textile material or leather, very preferably a textile material.

In one preferred embodiment of the process, the substrate is a textile material.

Textile materials in the context of the present invention include, for example, woven fabrics, knitted fabrics, and bonded and unbonded nonwoven fabrics. The textile materials may be formed from synthetic or natural fibers and/or mixtures thereof. In principle, textiles made from any desired fibers are suitable for the process of the invention. By means of the coating composition of the invention, it is possible to treat or upgrade the substrates in all customary ways, preferably by coating or bonding the fibers to one another and/or substrates to one another.

Before, during or after the application of the coating composition of the invention, the coated textile substrates can be surface treated, for example by pre-coating, peaching, velourizing, roughening and/or tumbling.

It is common to employ a multicoat construction in the textile coating. The coating in that case consists preferably of at least two coats, as the layers are generally also termed. The uppermost coat, the coat facing the air, is referred to as the topcoat. The lowermost side, the side facing the substrate, which joins the topcoat or other coats of the multicoat construction to the textile, is also referred to as a tie coat. In between them there may be one or more coats applied which in general are referred to as intermediate coats.

In connection with textile materials, the coating process of the invention may be used to produce topcoats, intermediate coats, and tie coats. The process is especially suitable for producing intermediate coats. These intermediate coats may be in compact or foamed form. In order to produce foamed intermediate coats, propellants may be employed. Propellants suitable for this purpose are known from the prior art.

Another particular advantage of the compositions of the invention is the fact, in particular, that they can be used to produce high-build coatings with just one, or very few, coat(s).

Likewise a subject of the invention is a coated substrate obtainable by the process of the invention.

On the basis of the outstanding performance properties, the coating compositions of the invention and/or the coats or adhesive bonds generated from them are suitable preferably for the coating of or production of substrates selected from the group consisting of outerwear, artificial leather articles, such as shoes, furniture covering materials, materials for the interior outfitting of automobiles, and sports items, or combinations of at least two of these. This recitation is given merely by way of example and should not, for instance, be understood as imposing any limitation.

A further subject of the invention is the use of the coating composition of the invention for producing elastic coatings or elastic films.

Elastic films and coatings in the context of this invention preferably have an elongation at break of ≥200%, preferably of ≥300%, or preferably of ≥400%, and/or a tensile strength of ≥2 MPa or preferably of ≥3 MPa, and a 100% modulus of ≥0.2 MPa or preferably of ≥0.3 MPa.

A further subject of the invention is an elastic film comprising a coating composition of the invention produced preferably by the process of the invention, wherein the elastic film has an elongation at break of ≥200%, preferably of ≥300%, or preferably of ≥400%, and/or a breaking stress of ≥2 MPa, or preferably of ≥3 MPa.

In one preferred embodiment of the elastic film, the film has a 100% modulus of ≥0.2 MPa, or preferably of ≥0.3 MPa.

The elastic films or coatings preferably have a swellability in water of ≤50%, more preferably ≤30%, and very preferably ≤10%.

To determine the degree of swelling, the free films were swollen in ethyl acetate at room temperature over 24 hours and the change in volume of the piece of film after swelling was ascertained by means of a ruler.

For this purpose, a film 0.1 to 0.2 mm thick was punched out in a size of 50*20 mm and stored in ethyl acetate at room temperature for 2 hours. The volume swell was calculated on the assumption that the change in all of the dimensions is proportional to one another.

The stated physical properties are determined as set out in the Methods section.

The present invention is elucidated using examples, which are not to be understood as being limiting.

### EXPERIMENTAL SECTION

Methods:

All reported percentages are based on weight unless otherwise stated.

The NCO contents were determined by titrimetry to DIN EN ISO 11909.

All the viscosity measurements were made with a Physica MCR 51 rheometer from Anton Paar GmbH (Germany) to DIN EN ISO 3219.

The 100% moduli, the breaking stress, and the elongation at break were measured to DIN 53504.

The number-average molecular weight Mₙ was determined by gel permeation chromatography (GPC) in tetrahydrofuran at 23° C. The procedure was in accordance with DIN 55672-1: “Gel permeation chromatography, Part 1—Tetrahydrofuran as eluent” (SECurity GPC System from PSS Polymer Service, flow rate 1.0 ml/min; columns: 2×PSS SDV linear M, 8×300 mm, 5 μm; RID detector). Polystyrene samples of known molar mass were used for calibration. The number-average molecular weight was calculated with software support. Baseline points and evaluation limits were fixed according to DIN 55672 Part 1.

Description of the Raw Materials:

All starting materials identified below are products of Covestro Deutschland AG.

Polyol 1: Trifunctional polyether of propylene oxide and ethylene oxide, prepared starting from glycerol, number-average molar weight Mₙ=6000 g/mol

Polyol 2: Difunctional polypropylene oxide ether, prepared starting with bisphenol A, number-average molar weight Mₙ=560 g/mol

Polyol 3: Glycerol-started trifunctional polypropylene oxide ether, prepared starting with glycerol, number-average molar weight Mₙ=3005 g/mol

Polyol 4: Difunctional polypropylene oxide ether, prepared starting with 1,2-propylene glycol, number-average molar weight Mₙ=2000 g/mol

Polyol 5: Difunctional polyester polyol formed from adipic acid and 1,6-hexanediol and neopentyl glycol, number-average molar weight Mₙ=2000 g/mol

Polyol 6: Difunctional polypropylene oxide ether, prepared starting with 1,2-propylene glycol, number-average molar weight M=1000 g/mol

Polyol 7: Difunctional polyester polyol formed from adipic acid and 1,6-hexanediol and neopentyl glycol, number-average molar weight Mₙ=1700 g/mol

Polyisocyanate 1: Meta-xylylene diisocyanate (XDI)

Polyisocyanate 2: 4,4′-Methylenebis(phenyl isocyanate), pure 4,4′-isomer (MDI)

Polyisocyanate 3: Tolylene diisocyanate (20% 2,6-tolylene diisocyanate and 80% 2,4-tolyl diisocyanate)

Polyisocyanate 4: Tolylene diisocyanate (100% 2,4-tolylene diisocyanate)

Polyisocyanate 5: Hexamethylene 1,6-diisocyanate (HDI)

Polyisocyanate 6: Isophorone diisocyanate (IPDI)

Diamine 1: 4,4′-Diamino-3,3′-dimethyldicyclohexylmethane (Laromin C 260, BASF, Germany)

Diamine 2: 4,4′-Diaminodicyclohexylmethane

N-Benzyl-tert-butylamine (BEBA): The material was acquired from Vertellus, Indianapolis, USA.

1-Methoxy-2-propyl acetate (MPA)

All further starting materials were acquired from Sigma Aldrich and used without further purification unless described otherwise in the specific case.

General Synthesis Protocol for the Inventive and Noninventive Examples 1 to 4 with the Compositions as Specified in Table 1:

The respective polyol mixture was stirred in a dewatering step at a pressure of 10 mbar at 100° C. for 1 hour in order to remove excess water from the mixture. If the mixture included 1,4-butanediol, this component was not added until after the polyol mixture dewatering step. The polyol mixture was thereafter brought to 65° C., and the amounts of Vulkanox BHT and triphenylphosphine specified in table 1 were added, and this mixture was homogenized by stirring at 65° C. for 10 minutes. Over the course of 1 minute, at this temperature, the diisocyanates specified in table 1 were then added (in the case of mixtures of diisocyanates, polyisocyanate 2 first and then polyisocyanate 3). A slightly exothermic reaction was ascertained, causing the mixture to heat up to a maximum of 75° C. The temperature was allowed to drop back to 65° C. and the reaction mixture was stirred at 65° C. until the free NCO group content had dropped to the theoretical level.

Then, at a temperature of 65 to 70° C., a stoichiometric amount of N-benzyl-tert-butylamine, corresponding to the NCO content determined in the reaction mixture, was added over the course of around 1 minute. A slight exothermic reaction was ascertained, since the temperature of the reaction mixture rose by a maximum of up to 5° C. If the viscosity of the reaction mixture increased too greatly, MPA was added during the reaction. Stirring was continued until IR spectroscopy (band at 2260 cm⁻¹) or NCO titration showed the NCO content to have dropped to zero. Where appropriate, after the end of the reaction, the reaction mixture was diluted by addition of a certain amount of MPA.

The reaction with DMP proceeded similarly, except that after attainment of the theoretical NCO value, at the first stage, DMP was added as a solid at 65° C. over the course of around 15 minutes. It was allowed to react at this temperature as described for the other blocking agent, until the NCO content had dropped to zero. Depending on the change in the viscosity of the reaction mixture, dilution was carried out during the reaction or after the end of the reaction, with the amount of MPA specified in table 1.

TABLE 1

| | Example 1 | Comparative | Example 2 | Comparative | Example 3 | Comparative | Example 4 | Comparative |
|---|---|---|---|---|---|---|---|---|
| | Inventive | example 1 | Inventive | example 2 | Inventive | example 3 | Inventive | example 4 |
| Material | amount [g] | amount [g] | amount [g] | amount [g] | amount [g] | amount [g] | amount [g] | amount [g] |
| Polyol 1 | 774.0 | 1548.0 | | | 137.5 | 137.5 | | |
| Polyol 2 | 48.4 | 96.8 | | | | | | |
| Polyol 3 | | | 68.0 | 136.0 | | | | |
| Polyol 4 | | | 383.2 | 766.4 | | | 219.0 | 219.0 |
| Polyol 5 | | | 225.0 | 450.0 | | | | |
| Polyol 6 | | | | | 68.8 | 68.8 | 439.0 | 439.0 |
| Polyol 7 | | | | | 98.8 | 98.8 | | |
| 1,4-Butanediol | | | | | 1.55 | 1.55 | | |
| Vulkanox BHT | 0.5 | 1.0 | 0.46 | 1.0 | 0.25 | 0.25 | 0.5 | 0.5 |
| Triphenylphosphine | 0.5 | 1.0 | 0.46 | 1.0 | 0.25 | 0.25 | 0.5 | 0.5 |
| Polyisocyanate 1 | 108.3 | | 130.22 | | 71.25 | | 207.2 | |
| Polyisocyanate 2 | | 138.8 | | 346.0 | | | | |
| Polyisocyanate 3 | | 101.2 | | | | 77.4 | | |
| Polyisocyanate 4 | | | | | | 12.0 | | 193.8 |
| N-Benzyl-tert-butylamine | 96.0 | 188.5 | 113.0 | 231.4 | 65.2 | 64.6 | 172.7 | 184.7 |
| 1-Methoxy-2-propyl | 55.0 | | 50.0 | 100.0 | 23.0 | 25.0 | 55.0 | 55.0 |
| acetate (MPA) | | | | | | | | |
| Viscosity (mPas) at | 27 000 | 82 000 | 23 000 | 165 000 | 24 200 | 135 300 | 22 000 | 51 000 |
| 23° C. | | | | | | | | |

Synthesis of Aliphatic Prepolymers Blocked with BEBA

### Comparative Example 5

A mixture of 774.0 g of polyol 1 and 48.0 g of polyol 2 was stirred at 100° C. and a reduced pressure of 10 mbar for 1 hour in order to remove excess water. This mixture was thereafter admixed over the course of 1-2 minutes at 75° C. first with 46.6 g of HDI and immediately thereafter with 64.6 g of IPDI. The resulting mixture was stirred at 75° C. for 5 hours and at 85° C. for 9 hours. The titrated NCO value showed that the reaction of the NCO groups with the OH groups had proceeded to completion.

Then, at a temperature of 65-70° C., a stoichiometric amount of N-benzyl-tert-butylamine (93.7 g), corresponding to the NCO content determined in the reaction mixture, was added dropwise over the course of around 15 minutes. A slight exothermic reaction was ascertained, since the temperature of the reaction mixture rose by a maximum of up to 5° C. Stirring was continued for 3.5 hours until IR spectroscopy showed the NCO content to have dropped to zero (band at 2260 cm⁻¹). The batch was diluted with 55 g of MPA to give a clear, viscous liquid. After standing at RT for 3 days, the batch had undergone crystallization and was no longer suitable for producing films. The storage stability of this blocked prepolymer was very limited, amounting to only a few minutes.

### Comparative Example 6

A mixture of 439.0 g of polyol 6 and 219.0 g of polyol 2 was stirred at 100° C. and a reduced pressure of 10 mbar for 1 hour in order to remove excess water. Added to this mixture thereafter at 65° C. over the course of 1 to 2 minutes were 184.8 g of HDI. The resulting mixture was stirred at 65-70° C. for 3 hours and at 80° C. for 11 hours. The titrated NCO value showed that the reaction of the NCO groups with the OH groups had proceeded to completion.

Then, at a temperature of 65-70° C., a stoichiometric amount of N-benzyl-tert-butylamine (93.7 g), corresponding to the NCO content determined in the reaction mixture, was added dropwise over the course of around 15 minutes. Following the addition of this amine, a further 55 g of MPA were added at the same temperature. A slight exothermic reaction was ascertained, since the temperature of the reaction mixture rose by a maximum of up to 85° C. The heating bath was removed and stirring was continued for 30 minutes, during which the free isocyanate groups reacted with the secondary amine groups. After an hour, the temperature had dropped to 70° C., and incipient hazing was evident. After a further 2 hours of subsequent stirring, the batch was no longer stirrable. After cooling to room temperature, the reaction mixture was cured right through. The reaction product was no longer stirrable and was difficult to dissolve in solvents. This batch was of only limited suitability for production of films.

The two preceding comparative examples 5 and 6 with aliphatic diisocyanates show that these prepolymers solidify very quickly after blocking of N-benzyl-tert-butylamine. Batches of this kind, in contrast to the inventive prepolymers, cannot be used for producing films with aliphatic diamines.

General Protocol for Investigating the Pot Life

The prepolymers of examples 1 to 4 and of comparative examples 1 to 4 were admixed in a plastic vessel with stoichiometric amounts—based on the blocked amounts of NCO—of diamine 1 and mixing took place on the Speedmixer at 3500 rpm for 1 minute. In cases of very high processing viscosity, as in examples 2 to 4 and also the associated comparative examples 2 to 4, the amounts of MPA specified in table 2 were added. The mixture is stored at RT, and the evolution in viscosity of the reaction mixture is measured after the times stated in table 2.

TABLE 2
Viscosity profiles of inventive examples 1 to 4 and of comparative examples 1 to 4 during the pot life investigations

| | Example 1 | Comparative | Example 2 | Comparative | Example 3 | Comparative | Example 4 | Comparative |
|---|---|---|---|---|---|---|---|---|
| | Inventive | example 1 | Inventive | example 2 | Inventive | example 3 | Inventive | example 4 |
| Amount of pre- | 20.0 | 20.0 | 20.0 | 20.0 | 20.0 | 20.0 | 20.0 | 20.0 |
| polymer (g) | | | | | | | | |
| Amount of | 1.29 | 1.25 | 1.70 | 1.51 | 2.04 | 1.94 | 2.30 | 2.46 |
| diamine (g) | | | | | | | | |
| MPA (g) | | | 1.0 | 1.0 | 1.0 | 1.0 | 1.0 | 1.0 |
| Viscosity, | 30 800 | 47 300 | 12 400 | 21 000 | 15 700 | 63 900 | 9150 | 14 600 |
| immediate (mPas) | | | | | | | | |
| Viscosity after | 31 100 | 76 000 | 12 700 | 26 300 | 16 500 | 85 000 | 9100 | 17 400 |
| 1 h (mPas) | | | | | | | | |
| Viscosity after | 32 100 | 89 300 | 12 400 | 30 600 | 16 200 | 98 350 | 9300 | 19 200 |
| 2 h (mPas) | | | | | | | | |
| Viscosity after | 30 800 | 108 000 | 12 700 | 37 000 | 16 200 | 112 300 | 9400 | 22 000 |
| 3 h (mPas) | | | | | | | | |
| Viscosity after | 30 700 | solid | 13 300 | 81 000 | 16 200 | 240 000 | 9800 | 38 600 |
| 7 h (mPas) | | | | | | | | |
| Viscosity after | 31 800 | | 14 400 | solid | 16 900 | solid | 10 500 | solid |
| 24 h (mPas) | | | | | | | | |

The prepolymers produced using m-XDI as diisocyanate component, in a mixture with an aliphatic diamine, exhibit no significant reaction on storage at room temperature. Mixtures of this kind can easily be processed at any point in time over one working day. The mixture has a sufficient pot life.

Those prepolymers produced with aromatic diisocyanates (MDI or TDI or mixtures thereof), in a mixture with the aliphatic amine, already react significantly after their contact at room temperature.

The viscosity of these mixtures goes up by a factor of two to three within one working day; after standing for one day, the mixtures are solid. Such mixtures cannot be processed during one working day. The pot life is significantly shorter.

Film Production from the Inventive Prepolymers (with XDI as Diisocyanate Component) and the Diamine 1 as Component B).

The inventive prepolymers of examples 1 to 4 were mixed with the stoichiometric amount of diamine 1, 3% of BYK 9565 (additive for PU-based synthetic leather, BYK Chemie GmbH, DE) and 0.5% of Acronal L 700 (acrylic resin in 50% ethyl acetate, plasticizer for coatings, BASF, DE) and the mixtures were stirred under reduced pressure for 3 minutes. A wet film layer of 300 μm is knife-coated onto BOR release paper, super-matt.

The film was dried in a forced air oven with the following parameters:

1 minute 90° C., heating to 130° C. within 1 minute, 1 minute 130° C., heating to 160° C. within 2 minutes, 5 min 160° C.

The tensile tests for determining the breaking stress and the elongation at break of the elastic films obtained were carried out in accordance with DIN 53504.

TABLE 3
Tensile tests:

| | | | Elongation |
|---|---|---|---|
| | 100% modulus | Brewing stress | at break |
| | (MPa) | (MPa) | (%) |
| Prepolymer inventive | 1.40 | 8.48 | 824 |
| ex. 1 + diamine 1 | | | |
| Prepolymer inventive | 1.74 | 2.68 | 330 |
| ex. 2 + diamine 1 | | | |
| Prepolymer inventive | 2.55 | 4.4 | 653 |
| ex. 4 + diamine 1 | | | |

The inventive prepolymer of example 1 was mixed with the stoichiometric amount of diamine 2 and formulated as described above, applied by knife-coating, and cured to form a film. Tensile testing on the resultant film produced the following results.

TABLE 4
Tensile tests

| | | | Elongation |
|---|---|---|---|
| | 100% modulus | Breaking stress | at break |
| | (MPa) | (MPa) | (%) |
| Prepolymer inventive | 0.89 | 10.1 | 1291 |
| ex. 1 + diamine 2 | | | |

The results show that the inventive prepolymers with m-XDI as diisocyanate component, on crosslinking with an aliphatic diamine, produce elastic films. The prepolymers of comparative examples 1 to 4 were not investigated, because the reaction of the blocked isocyanate groups with the aliphatic diamine even started uncontrollably at ambient temperatures, and, on account of the low pot life, no technically usable formulations were obtained.

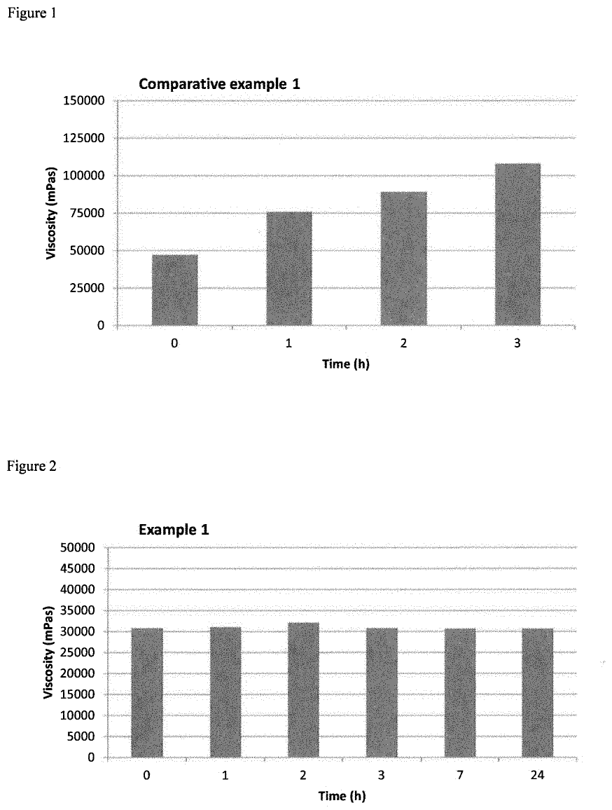

Results from the viscosity measurements or else pot life investigations, as listed in table 2 for the comparative examples 1 to 4 and the inventive examples 1 to 4, are shown in the form of graphs in FIGS. 1 to 8. What the figures show individually is as follows:

FIG. 1: a bar chart relating to the viscosity increase of comparative example 1 over a period of 3 hours;

FIG. 2: a bar chart relating to the viscosity increase of example 1 over a period of 24 hours;

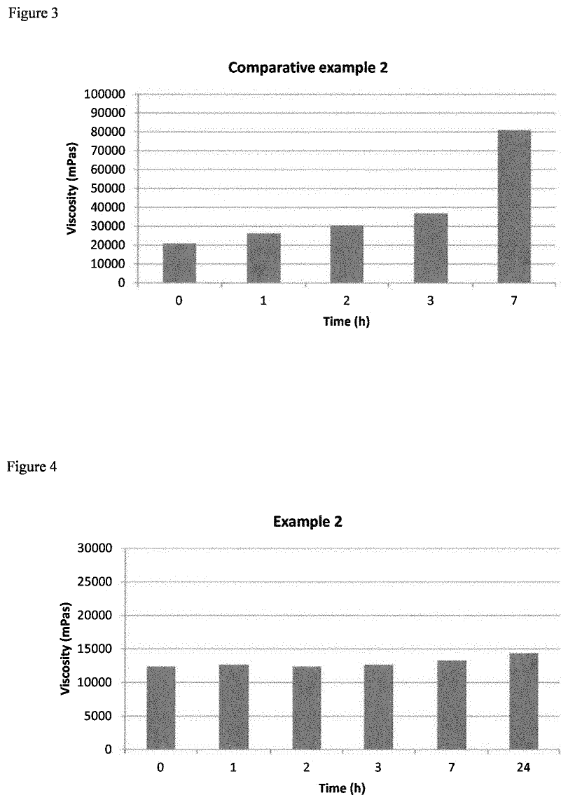

FIG. 3: a bar chart relating to the viscosity increase of comparative example 2 over a period of 7 hours;

FIG. 4: a bar chart relating to the viscosity increase of example 2 over a period of 24 hours;

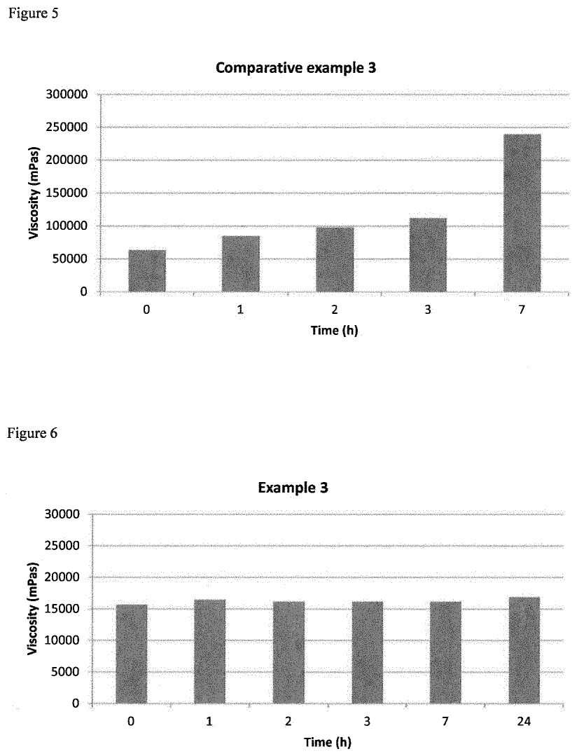

FIG. 5: a bar chart relating to the viscosity increase of comparative example 3 over a period of 7 hours;

FIG. 6: a bar chart relating to the viscosity increase of example 3 over a period of 24 hours;

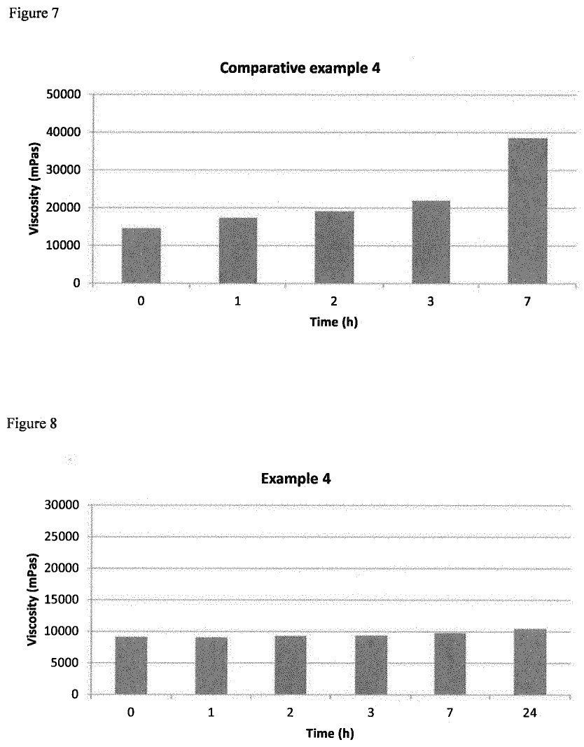

FIG. 7: a bar chart relating to the viscosity increase of comparative example 4 over a period of 7 hours;

FIG. 8: a bar chart relating to the viscosity increase of example 4 over a period of 24 hours.

FIG. 1 illustrates the evolution of the viscosity of the mixture from comparative example 1 after addition of the amounts of diamine specified in table 2 to the prepolymer prepared from aromatic polyisocyanates as component b), over 3 hours. It can be seen that within the first 3 hours there is a rise in the viscosity from around 47 300 MPas to a value of more than 100 000 MPas, which represents a doubling in the viscosity values. After just 7 hours, therefore, this mixture could no longer be processed, being completely solid, as evident from the values in table 2.

FIG. 2 shows the evolution in viscosity of inventive example 1 from table 2 after the addition of the diamine. It is clearly evident here from the bars at the time points 0, 1, 2, 3, 7 and 24 hours that the viscosity changes only very moderately, namely by not more than 15% of the value at the time point t=0, over this period, and that processability over 24 hours is ensured.

FIG. 3 illustrates the evolution of the viscosity of the mixture from comparative example 2 after addition of the amounts of diamine specified in table 2 to the prepolymer prepared from aromatic polyisocyanates as component b), over 7 hours. It can be seen that within the first 3 hours there is a rise in the viscosity from around 21 000 MPas to a value of more than 80 000 MPas, which represents a fourfold increase in the viscosity values. After just 24 hours, therefore, this mixture could no longer be processed, being completely solid, as evident from the values in table 2.

FIG. 4 shows the evolution in viscosity of inventive example 2 from table 2 after the addition of the diamine. It is clearly evident here from the bars at the time points 0, 1, 2, 3, 7 and 24 hours that the viscosity changes only very moderately, namely by not more than 15% of the value at the time point t=0, over this period, and that processability over 24 hours is ensured.

FIG. 5 illustrates the evolution of the viscosity of the mixture from comparative example 3 after addition of the amounts of diamine specified in table 2 to the prepolymer prepared from aromatic polyisocyanates as component b), over 7 hours. It can be seen that within the first 3 hours there is a rise in the viscosity from around 64 000 MPas to a value of more than 240 000 MPas, which represents a fourfold increase in the viscosity values. After just 24 hours, therefore, this mixture could no longer be processed, being completely solid, as evident from the values in table 2.

FIG. 6 shows the evolution in viscosity of inventive example 3 from table 2 after the addition of the diamine. It is clearly evident here from the bars at the time points 0, 1, 2, 3, 7 and 24 hours that the viscosity changes only very moderately, namely by not more than 15% of the value at the time point t=0, over this period, and that processability over 24 hours is ensured.

FIG. 7 illustrates the evolution of the viscosity of the mixture from comparative example 4 after addition of the amounts of diamine specified in table 2 to the prepolymer prepared from aromatic polyisocyanates as component b), over 7 hours. It can be seen that within the first 3 hours there is a rise in the viscosity from around 14 000 MPas to a value of more than 38 000 MPas, which represents more than a threefold increase in the viscosity values. After just 24 hours, therefore, this mixture could no longer be processed, being completely solid, as evident from the values in table 2.

FIG. 8 shows the evolution in viscosity of inventive example 4 from table 2 after the addition of the diamine. It is clearly evident here from the bars at the time points 0, 1, 2, 3, 7 and 24 hours that the viscosity changes only very moderately, namely by not more than 15% of the value at the time point t=0, over this period, and that processability over 24 hours is ensured.

From the results of the experiments as represented in table 2 and in FIGS. 1 to 8 it can be read off that through the use of araliphatic isocyanates as component b) for provision of the coating composition of the invention, in comparison to aromatic isocyanates for the provision of coating compositions, with otherwise identical components, it becomes possible to achieve an extension to pot life of at least 100%, or rather 300%, or even rather 500%, based on the pot life with the respectively comparable aromatic isocyanate.

1. A coating composition for the elastic coating of textile materials, comprising
at least one blocked, isocyanate-terminated prepolymer (component A), the isocyanate-terminated prepolymer being prepared from a polyol component a) and an araliphatic isocyanate component b), and the terminal isocyanate groups being blocked with N-alkyl-benzylamines or partly with N-alkyl-benzylamines and partly with 3,5-dimethylpyrazole, at least one polyamine (component B), and
≤30% by weight, based on the total mass of the coating composition, of at least one organic solvent.

2. The coating composition as claimed in claim 1, wherein the terminal isocyanate groups of the isocyanate-terminated prepolymer consist of tetramethylxylylene diisocyanate (m- or p-TMXDI) or xylylene diisocyanate (m- or p-XDI) or a mixture thereof.

3. The coating composition of claim 1, wherein the polyol component a) comprises at least two different polyols, a first and at least one further polyol.

4. The coating composition of claim 1, wherein the terminal isocyanate groups of the prepolymer are blocked with N-tert-butylbenzylamine.

5. The coating composition of claim 1, wherein component B) comprises at least one diamine or consists exclusively of one or more diamines.

6. The coating composition of claim 1, wherein the ratio of the isocyanate groups in component b) to hydroxyl groups in component a) is ≥1.5:1.

7. The coating composition of claim 1, wherein the coating composition comprises ≤10% by weight, based on the total mass of coating composition, of at least one organic solvent.

8. The coating composition of claim 1, wherein component b) has an average NCO functionality in a range from 1.5 to 4.0.

9. The coating composition of claim 1, wherein the weight ratio of component A) to component B) is ≤10:3.

10. A process for the coating of substrates, wherein a coating composition of claim 1 is applied to a substrate and crosslinked at a temperature in a range from 90 to 200° C.

11. The process as claimed in claim 10, characterized in that the substrate is a textile material.

12. A coated substrate obtainable by the process of claim 10.

13. The use of a coating composition of claim 1 for producing elastic coatings or elastic films.

14. An elastic film comprising the coating composition of claim 1, wherein the elastic film has an elongation at break of ≥200% and/or a breaking stress of ≥2 MPa.

15. The elastic film as claimed in claim 14, wherein the elastic film has a 100% modulus of ≥0.2 MPa.
